(19) United States
(12) Patent Application Publication
(10) Pub. No.: US 2009/0101142 A1
(43) Pub. Date: Apr. 23, 2009

(54) Nasal Cannula

(76) Inventor: Eric Lang, McMinnville, TN (US)

Correspondence Address: ROBERT M. SCHWARTZ, P.A., P.O. BOX 221470, HOLLYWOOD, FL, 33022, US

(21) Appl. No.: 12/239,871

(22) Filed: Sep. 29, 2008

Related U.S. Application Data
(60) Provisional application No. 60/976,588, filed on Oct. 1, 2007.

(51) Int. Cl. A62B 18/00

(52) U.S. Cl. 128/201.22

(57) ABSTRACT

The present invention is a nasal oxygen supply cannula and head support structure, having a tube with a proximal end connected to an oxygen supply and a distal end connected to a nosepiece having a one or more intra-nasal oxygen delivery output ports, a head support on the head of a patient, and a mechanism for securing the cannula to the cap.

### INDEX TO RELATED APPLICATIONS

This application claims benefit of U.S. Provisional Patent Application 60/976,588, filed Oct. 1, 2007, the disclosure of which is incorporated herein by reference in its entirety.

### BACKGROUND OF THE INVENTION

1. Technical Field

The present invention relates generally to nasal oxygen cannula technology, and in particular, to an apparatus and method for stabilizing and anchoring nasal oxygen cannulas in a secure and comfortable manner.

2. Description of the Related Art

Nasal oxygen cannulas are utilized to deliver oxygen directly to nasal airways in order to infuse oxygen into the inspirational airflow of patients in need of such therapy. Typically, these systems include a relatively large bore plastic supply tube as a conduit for providing gas flow from a pressurized oxygen source to proximal ends of a pair of plastic oxygen delivery tubes having relatively smaller bores. In a typical nasal cannula configuration, the distal ends of the delivery tubes enter into opposite ends of a short, expanded piece of plastic tubing that are outlets for oxygen to be delivered to the nasal cavity. The terms “cannula,” “nasal cannula,” and “nasal oxygen cannula” are utilized throughout this specification and within the claims interchangeably, and refer, collectively and individually to an apparatus or device comprised of various tubing and associated retention/anchoring structure for delivery oxygen or other respiratory gases or mixtures of respiratory gases to a patient through the patient's external nasal passages.

An example prior art nasal oxygen cannula is depicted in FIG. 1. Starting at the distal end, as shown in FIGS. 1a, 1b, and 2.

To ensure adequate and uninterrupted oxygen delivery, nasal cannulas must be securely positioned such that the delivery outlet ports are maintained in secure alignment with a patient's nostrils. Conventional catheter/cannulas have largely depended upon the use of the pair of oxygen delivery tubes, such as those depicted in FIGS. 1a, 1b, and 2, to maintain the cannula delivery ports within the patient's nostrils. By looping each of two delivery tubes over the top of each ear, a portion of the tube becomes trapped in the sulcus area between the ear and the skin of the head. The traction provided by trapping the tubes within the sulcus, prevents free movement of the delivery tubes and thus provides stabilization of the oxygen delivery barrel under a patient's nose.

The delivery tube ear loop configuration achieves limited cannula stabilization that resists displacement of the delivery ports upon movement of the patient's head. However, there are also many disadvantages and limitations related to utilizing this conventional apparatus and method. For example, patients tend to move their heads during sleep, resulting in an associated movement of the pair of oxygen delivery tubes looped behind the ears. Movement of these tubes often causes irritation, abrasion and pain arising from friction at the skin folds comprising the sulcus between the ear and lateral head area. Responsive to such irritation and pain, patients often “shake off” the catheter/cannula resulting in considerable sleep interruption and, more importantly, interruption of the patient's necessary oxygen supply.

The present invention addresses this difficulty by providing a nasal cannula and support apparatus that does not use a patient's ears for positioning and support.

### BRIEF SUMMARY OF THE INVENTION

The present invention provides for a nasal cannula as is known secured to an apparatus on the top and or rear portion of a patient's head.

In one embodiment, a securing apparatus or head support comprises an elastic mesh resembling a skullcap. The cannula is connected to the head support which is then placed on a patient's head. Because the securing is effectuated by connection of the cannula oxygen tubes to the head support the discomfort of using a patient's ears for structural support is eliminated.

The head support may be made of any acceptable material such that it may be worn by a patient and have sufficient strength to secure the nasal cannula into position.

In a preferred embodiment, the head support is adjustable to any size head or crown.

### BRIEF DESCRIPTION OF THE DRAWINGS

FIG. 1a is a front view of a nasal cannula as are commonly used.

FIG. 1b is a top view of a nasal cannula as are commonly used.

FIG. 2 is a side view of a nasal cannula as are commonly used.

FIG. 3 is a top view of a nasal cannula and support apparatus of the present invention.

FIG. 4 is a front view of a nasal cannula and support apparatus of the present invention worn on a person.

FIG. 5 is a top view of a nasal cannula and support apparatus of the present invention worn on a person.

FIG. 6 is a side view of a nasal cannula and support apparatus of the present invention worn on a person.

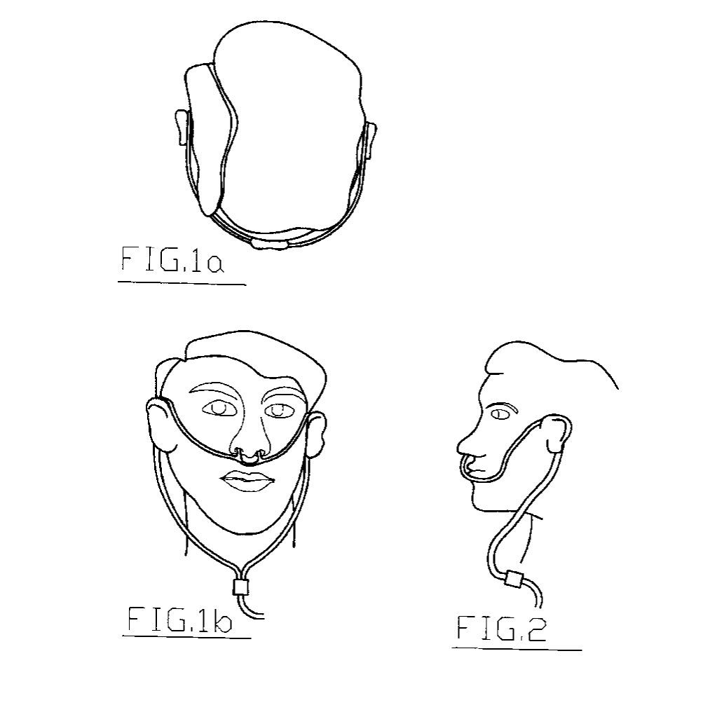

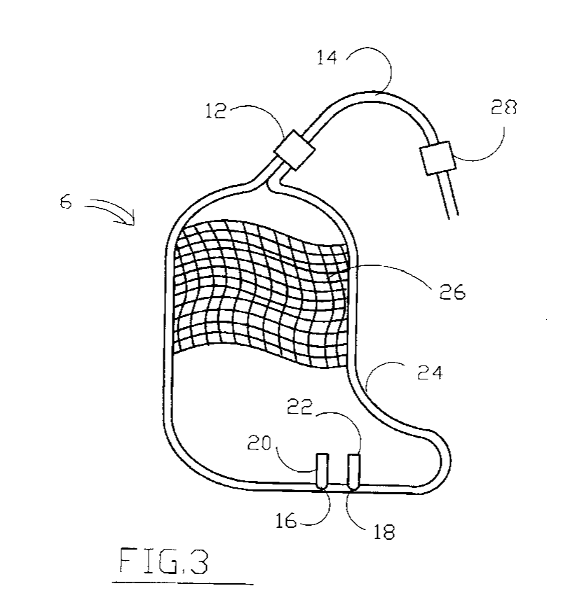

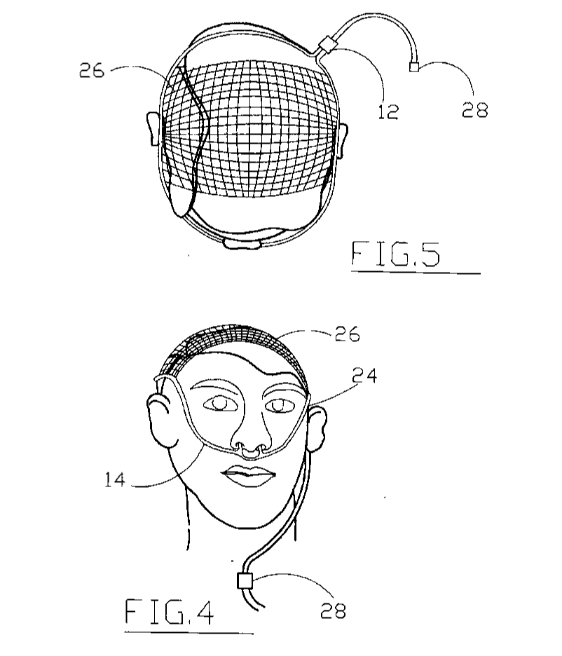

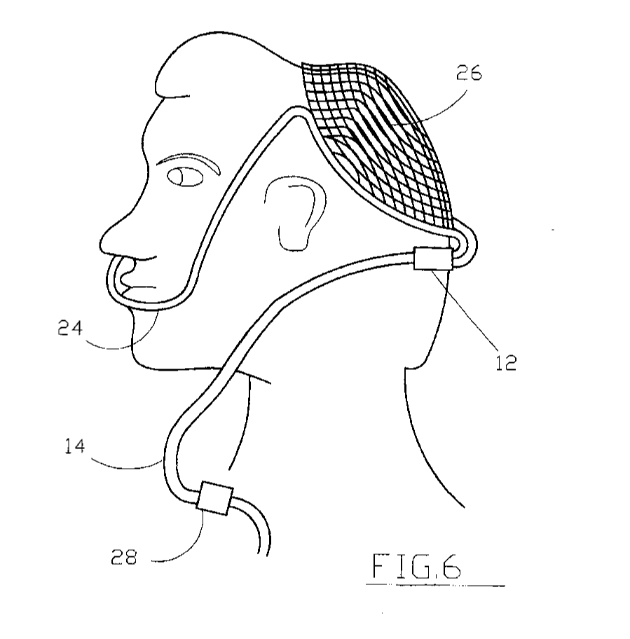

### DETAILED DESCRIPTION OF THE PREFERRED EMBODIMENTS

Cannula assembly 6 has main oxygen inlet 14 that has an inlet connector 28 and tube divider 12. Tube divider 12 has a first oxygen supply tube 14 and a second oxygen supply tube 24 exiting therefrom. Each of first oxygen supply tube 14 and a second oxygen supply tube 24 are secured to a head support 26. Each of first oxygen supply tube 14 and a second oxygen supply tube 24 supply oxygen to first nasal inlet 16 and second nasal inlet 18. First nasal inlet 16 and second nasal inlet 18 have first nasal outlet 20 and second nasal outlet 22 respectively that supply oxygen directly to the nasal cavity, as is known in the art.

Each of first oxygen supply tube 14 and a second oxygen supply tube 24 are connected to head support 26 by any acceptable manner. Most preferred is a securing to head support 26 that is constructed and arranged to rest on the top, back, or any region of the user's head such that the user may secure a nasal cannula into position without utilizing the ears for support.

Inlet connector 28 is attached to an oxygen supply as is known. Oxygen travels into cannula assembly 6 through oxygen supply tube 14. The supply of oxygen is divided at tube divider 12 and first oxygen supply tube 14 and a second oxygen supply tube 24 deliver oxygen traveling with each oxygen supply tube 14 and 24. First oxygen supply tube 14 and a second oxygen supply tube 24 are secured to head support 26. Preferrably, first oxygen supply tube 14 and a second oxygen supply tube 24 are stitched to the outer perimeter of head support 26.

Typically, first nasal inlet 16 and second nasal inlet 18 are inserted into the nostrils of a person. Head support 26 is positioned on the head such that there is sufficient tension to secure first nasal inlet 16 and second nasal inlet 18 each within a single nostril. After head support 26 is secured, inlet connector 28 is connected to a source of oxygen. The person wearing cannula assembly 6 then begins to receive oxygen directly into the nasal cavity.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A nasal oxygen supply cannula and support apparatus comprising:
a. a tube having a proximal end connected to an oxygen supply and a distal end connected to a nosepiece having a one or more intra-nasal oxygen delivery output ports;
b. a head support on the head of a patient;
c. connecting mechanism for securing the cannula to the cap.

2. The apparatus of claim 1 wherein the head support is formed of flexible material.

3. The apparatus of claim 1 wherein the head support is formed of elastic mesh.

4. The apparatus of claim 1 wherein the head support is adjustable.

5. A method of providing oxygen or therapeutic gas therapy to a patient comprising:
a. providing a nasal cannula;
b. providing a head support for the cannula;
c. attaching the cannula to the head support;
d. positioning cannula nasal outlets in the nostrils of a person;
e. attaching the securing apparatus to a patient's head; connecting the cannula inlet to a supply of oxygen or any other therapeutic gas.
